(19) United States
(12) Patent Application Publication
(10) Pub. No.: US 2003/0012891 A1
(43) Pub. Date: Jan. 16, 2003

(54) Method and device for marking objects with sintered mineral powders

(76) Inventors: Arnaud Hory, Limoges (FR); Jean-Marie Gaillard, Limoges (FR)

Correspondence Address: YOUNG & THOMPSON, 745 SOUTH 23RD STREET 2ND FLOOR, ARLINGTON, VA, 22202

(21) Appl. No.: 09/555,875

(22) PCT Filed: Dec. 7, 1998
(86) PCT No.: PCT/FR98/02644

(30) Foreign Application Priority Data
Dec. 8, 1997 (FR) 97/15808

(51) Int. Cl. B05D 5/00; B05D 3/02

(52) U.S. Cl. 427/596; 427/190; 427/261

(57) ABSTRACT

The invention concerns a method for marking an object with mineral powders, characterised in that in consists in depositing on the substrate a coat consisting of mineral powders, producing a marking on the substrate coated surface using a laser beam, said laser beam providing the energy required for sintering the coat irradiated particles, and for generating a diffusion between the sintered particles and the substrate; and removing the non-irradiated coating part using cleaning means. The invention also concerns the associated device, characterised in that it comprises a table (32) whereon is arranged the substrate (10), a laser (16), depositing means (20). cleaning means (18), and control means (26) for controlling the laser beam shot (16).

The present invention has for its object a process and device for marking objects with mineral powders.

This process permits particularly decorating objects of different geometric shapes and materials by sintering mineral powders on their surface.

A first process for marking is described in the patent application EP-A1-0 647 885, and particularly permits decorating glass or ceramic products with a composition of colored ceramic powders.

According to this process, in the first instance, the particles which comprise said composition are applied to a transfer means, for example a paper covered with gum arabic, with the help of an electrophotographic reproduction process.

Then, a transfer means covered with the composition is applied to the ceramic or glass support to be baked.

It is known that this process can be used only for glass or ceramic supports, the baking temperature of the composition being high. Moreover, this process is long and imprecise because of the numerous dispersions, at the moment of the deposit of the composition of the powders on the transfer means and the application of said means to the support.

Another marking process is described in the patent application EP-A-0 432 653, and permits applying ceramic decoration on vitro ceramic, glass, ceramic or like supports.

According to this process, the decorations, pre-formed of ceramics, are first deposited in the form of layers on a support, to secure them, they are then subjected to energy supplied by a laser beam so as to heat this layer and the superficial layer of the support until softening or fusion of said layers.

Here again, this process can be applied only to supports that are resistant to the heat to which they are directly subjected, for example glass and ceramic, because of the high temperatures of fusion of the ceramic decoration. It is also known that this process does not permit obtaining marking strokes of high definition because the decorations are preformed before being applied to their support.

Other marking processes with the help of a laser beam are known, but they all modify the crystalline structure of the support or its chemical composition. This is the case particularly with the patent FR-A-2.485.418 which permits marking on glass by modifying the optical permeability of the irradiated glass, or the patent EP-A1-0 741 117, which permits marking reversibly ceramic supports by reduction of the oxide present in the doped ceramic.

The present invention seeks to overcome these drawbacks by providing marking with the help of sintered mineral powders on a support of a material and geometric shape of any type, without modifying the crystalline or chemical structure of said support, the process permitting resistant and rapid marking with a great improvement relative to the prior art, as to the fineness of the decoration.

To this end, the invention has for its object a marking process of an object with mineral powders, characterized in that it comprises the steps consisting in:

coating the substrate with a coating constituted by mineral powders,

carrying out marking on the coated surface of the substrate with the help of a laser beam, said laser beam supplying the energy necessary to sinter the irradiated particles of the coating, and to create a diffusion phenomenon between the sintered particles and the substrate, and

removing the non-irradiated portion of the coating with the help of cleaning means.

Preferably, the laser that is used is an infrared laser, and the coating composition is constituted by a ceramic matrix and if desired pigments.

According to one embodiment, the ceramic matrix is preferably constituted by an alkali and/or alkaline earth silico-aluminate and/or a borosilicate.

The invention also has for its object a device for practicing said process, which comprises a table on which is disposed the substrate, a laser, deposit means, cleaning means, and guide means which permit guiding the stroke of the laser beam.

Other characteristics and advantages will become apparent from the description which follows of the process and the associated device according to a preferred embodiment, which description is given only by way of example, with reference to the accompanying drawings, in which:

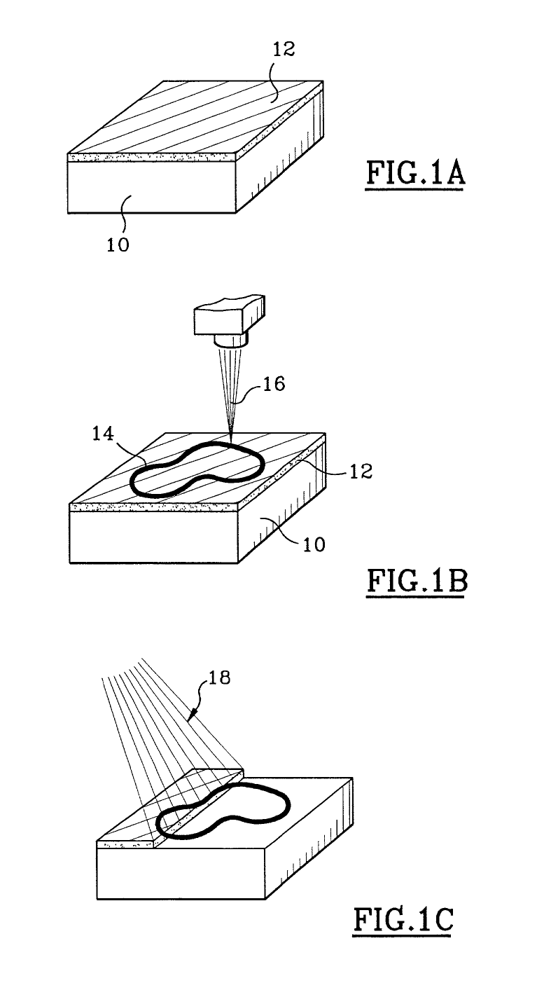

FIGS. 1A, 1B, 1C show the synopsis of the process,

FIG. 2 is a transverse cross-section of the support during the second step of the process, and

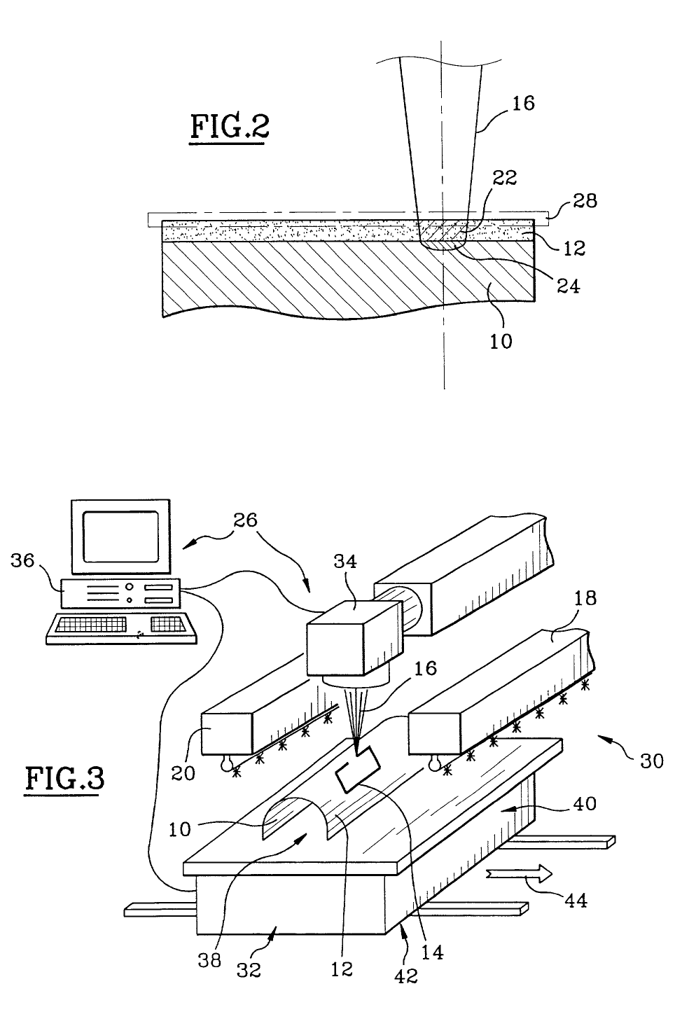

FIG. 3 is a diagram showing the principle of the associated device.

According to the invention, the process for marking objects with sintered mineral powders comprises steps consisting in:

1/ coating a substrate 10 with a coating 12 constituted by mineral powders over all the surface to be marked (FIG. 1A),

2/ carrying out a marking 14 on the coated surface of the substrate 10 with the help of a laser beam 16, this latter supplying sufficient energy to sinter the particles of the irradiated coating, and to create a phenomenon of diffusion between the sintered particles and the substrate 10, (FIG. 1B),

3/ removing the non-irradiated portion of the coating with the help of cleaning means 18 (FIG. 1C).

This marking process can be used on substrate of any material, organic or mineral, having for its geometric shape a flat surface or not.

The different steps of the process will now be described in detail.

During the first step, the substrate 10 is covered over all its surface to be marked, with the coating 12, of a substantially constant thickness, by the help of deposition means 20 known to those skilled in the art. This deposition can be particularly carried by serigraphy, by roller coating or brush coating, by spraying or dipping. The coating 12 must adhere sufficiently to the substrate 10 to permit the substrate/coating assembly to be handled, but this adherence must be limited such that the coating 12 may be removed from the substrate by simple washing.

The coating composition, which is adapted as a function of the substrate, is obtained by the addition of a ceramic matrix, of colored pigments and if desired of additives to adapt the composition to the different parameters of the laser beam.

The ceramic matrix is preferably constituted by an alkali and/or alkaline earth silico-aluminate, and/or a borosilicate, and the chemical elements of the ceramic matrix can be natural products (feldspar, clay, kaolin, . . . ) or synthetic products (oxides).

Moreover, the pigments are selected as a function of their ability to color the coating, and are preferably constituted by coloring oxides, or by a mixture of coloring oxides and/or natural minerals.

The second step, shown in detail in FIG. 2, consists in carrying out the marking properly so called with the help of a laser beam 16.

Thanks to the adsorption properties of the coating material 12, the laser beam 16 supplies the quantity of energy necessary for sintering the ceramic particles located in a sintered region 22 of the coating 12, and in the diffusion between said zone 22 and an attachment zone 24 of the substrate, which is superficial and is located below the sintered zone 22. This diffusion between the two zones permits solidly securing the particles of sintered zone 22 on the substrate 10 and to obtain a resistant marking.

During this step, the laser 16 is directed by the control means 26 which permit moving the focal point of the radiation in a focalizing region 28, the surface of the coating 12 being disposed in the zone 28. These control means 26, which are comprised in known fashion of mirrors and a computer interface, permit, thanks to software, reproducing at the surface of the object any digital decoration, the sintered zone corresponding to this decoration.

According to the invention, the sintering can be carried out either in solid phase or in liquid phase, and the fusion temperature of the coating 12 can be higher than that of the substrate 10. Thus, during marking, the coating plays the role of a thermal barrier by also absorbing the energy, diffusion being an endothermic reaction, whereby the temperature gradient in the coating 12 is such that the temperature at the level of the junction between the coating 12 and the substrate 10 remains less than the melting temperature of this latter.

Also, this process can be used in the glass industry, in which the fusion temperatures are low, and it permits obtaining more resistant markings, adapted to resist particularly wash cycles dishwasher.

On the other hand, the sintering is influenced by numerous factors, particularly by the properties of the powders themselves, the morphology, dimensions, purity, and by conditions of processing, temperature, time.

Thus, as a function of the characteristics of the powders used of the thickness of the coating, the parameters of the stroke of the laser beam 16 are determined, which comprise particularly the wavelength, the mean power emitted, the speed of sweeping and the frequency of pulsation.

It should be noted that these parameters are interdependent. For a given composition, the increase of power gives rise to an increase of the speed of sweeping.

According to a particular embodiment, the laser used is of the infrared type.

During the third step, the non-irradiated portions of the coating are removed by the cleaning means 18. The cleaning is particularly carried out by washing with a jet of water, by immersion in a solvent, by mechanical scrubbing, or else by immersion in a liquid subject to ultrasonic waves.

By way of example, for marking ceramic substrates of the faience, stoneware or porcelain type, there is used:

a ceramic matrix of the mol formula:

| | |
|---|---|
| SiO₂ | from 3.0 to 3.85 |
| Al₂O₃ | from 0.3 to 0.4 |
| K₂O | from 0.25 to 0.35 |
| Na₂O | from 0.05 to 0.20 |
| CaO | from 0.45 to 0.50 |
| MgO | from 0.05 to 0.12 |
| BaO | from 0.00 to 0.10 |

and a blue pigment of a mass composition:

| | |
|---|---|
| Al₂O₃ | 54% |
| ZnO | 3% |
| CoO | 35% |
| Zircon | 8% |

the composition of the coating being constituted by 75% ceramic matrix and 25% pigment by weight.

The parameters of the stroke associated with this composition are tabulated as a function of the desired precision, in the following table:

| Infrared wavelength | 1 μm | 10 μm |
|---|---|---|
| Mean power in W | 10 to 12 | 4 to 8 |
| Speed of sweeping in mm/s | 40 to 80 | 150 to 250 |
| Frequency in kHz | 30 to 50 | |
| Thickness of the coating in μm | 20 to 50 | 20 to 50 |
| after sintering | | |
| Precision of marking | ±5 μm | ±25 μm |

It should be noted that the precision and definition of marking depend on the wavelength, the diameter of the laser spot and on the control software.

A diagram of the principle of the device 30 permitting the practice of the process according to the invention is shown in FIG. 3 during the second step.

There will be seen the substrate 10, covered with coating 12, disposed on a table 32 located below the laser beam 16. This latter is directed by control means 26 which permit carrying out marking 14 from a digitized image.

These control means 26 are constituted by mechanical means 34, which comprise in known manner mirrors which orient the beam, and a computer interface 36 which controls the mirrors, so as to carry out digital decoration.

The table 32, on which is secured the substrate 10 by securement means 38, also comprises orientation means 40, under the control of the control means 26, so as to arrange the surface of the substrate 10 always within the focal zone of the laser 16. With such an arrangement, the device 30 permits carrying out markings on non-planar surfaces.

Upstream of the laser beam 16, there will be seen the deposit means 20, which permit coating the substrate 10 during the first step. According to a preferred embodiment, the deposit is carried out by spraying.

Downstream, there will be seen the cleaning means 18, comprising liquid jets, which permit during the third step removing the non-irradiated portions of the coating, hence unsintered and whose adhesion capacity on the substrate is limited. After this third step, there remain only the sintered portions of the coating which have the shape of the digitized decoration.

The table 32 also comprises means 42 for movement according to the arrow 44 during the different steps. Thus, the substrate is disposed below the deposition means 20 during the first step, below the laser 16 during the second step, and below the cleaning means 18 during the third step.

1. Process for marking an object with mineral powders, characterized in that it comprises the steps which consist in:
coating the substrate with a coating constituted by mineral powders,
carrying out marking on the coated surface of the substrate with a laser beam, said laser beam supplying the energy necessary to sinter the irradiated particles of the coating, and to create a diffusion phenomenon between the sintered particles and the substrate, and
removing the non-irradiated portion of the coating with the help of cleaning means.

2. Marking process according to claim 1 or 2, characterized in that the laser used is an infrared laser.

3. Marking process according to any one of the preceding claims, characterized in that the composition of the coating is constituted by a ceramic matrix.

4. Marking process according to claim 3, characterized in that the coating composition comprises in addition to the ceramic matrix, pigments.

5. Marking process according to claim 3 or 4, characterized in that the ceramic matrix is constituted by an alkali and/or alkaline earth silico-aluminate, and/or a borosilicate.

6. Device for practicing the marking process according to any one of the preceding claims, characterized in that it comprises a table (32) on which is disposed the substrate (10), a laser (16), deposition means (20), cleaning means (18), and control means (26) which permit controlling the stroke of the laser beam (16).

7. Marking device according to claim 6, characterized in that the control means (26) comprise mechanical means (34) constituted or mirrors, and a computer interface (36).

8. Marking device according to claim 6 or 7, characterized in that the table (32) comprises orientation means (40) controlled by the control means (26), and displacement means (42).
